(19) United States
(12) Patent Application Publication
(10) Pub. No.: US 2011/0282829 A1
(43) Pub. Date: Nov. 17, 2011

(54) WORKFLOW TASK ROUTING BASED ON CARDINALITY OF TASK DATA

(75) Inventors: Ravi Rangaswamy, Fremont, CA (US); Will Stallard, Vallejo, CA (US); David C. Lam, Sunnyvale, CA (US)

(73) Assignee: ORACLE INTERNATIONAL CORPORATION, REDWOOD SHORES, CA (US)

(21) Appl. No.: 12/780,348

(22) Filed: May 14, 2010

(51) Int. Cl. G06F 17/30

(52) U.S. Cl. 707/608; 707/755; 707/E17.008

(57) ABSTRACT

A system and method for workflow task routing based on cardinality of task data, or the structure of elements in a business object associated with a task. In accordance with an embodiment, a system such as a human workflow system, that allows for the definition of human workflow tasks, can include a forEach construct within a human task routing definition and a payload. In scenarios that require a plurality of task of similar type be undertaken, such as a purchase order approval involving a plurality of items and potentially different approvers, the system allows for modeling a separate routing for each of those task items (e.g. the lines in the purchase order). In each of the branches of the forEach construct, complex routing patterns, such as parallel routing, can be used. The forEach construct allows creating of looping constructs at any level deep.

### CROSS REFERENCE TO RELATED APPLICATIONS

This application is related to the following patent applications, which are each hereby incorporated by reference in their entirety:

U.S. patent application No. ______, titled “COMPLEX ACCESS CONTROL”, inventors Vladimir Svetov et al., filed (Attorney Docket No. ORACL-5077US0);

U.S. patent application No. ______, titled “INTEGRATING EXTERNAL DATA IN HUMAN WORKFLOW TASKS”, inventors Ravi Rangaswamy et al., filed (Attorney Docket No. ORACL-5078US0);

U.S. patent application No. ______, titled “FLEXIBLE CHAINING OF DISPARATE HUMAN WORKFLOW TASKS IN A BUSINESS PROCESS”, inventors Ravi Rangaswamy et al., filed (Attorney Docket No. ORACL-5079US0);

U.S. patent application No. ______, titled “SYSTEM AND METHOD FOR LOGICAL PEOPLE GROUPS”, inventors Ravi Rangaswamy et al., filed (Attorney Docket No. ORACL-5081US0); and

U.S. patent application No. ______, titled “DYNAMIC HUMAN WORKFLOW TASK ASSIGNMENT USING BUSINESS RULES”, inventors Ravi Rangaswamy et al., filed (Attorney Docket No. ORACL-5082US0).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention is generally related to software modeling and development, and to business and human workflows, and is particularly related to a means of workflow task routing based on cardinality of task data, or the structure of elements in a business object associated with a task.

### BACKGROUND

In software development, a service oriented architecture (SOA) composite application is an assembly of services, service components and references, which are designed and deployed together to meet a particular business need. SOA allows for the development of enterprise applications as modular business web services that can be easily integrated and reused. To rapidly respond to competitors, and best exploit organizational assets, many companies have adopted SOA to accommodate their complex application environments.

Products such as Oracle SOA Suite provide a complete set of service infrastructure components for designing, deploying, and managing composite applications, including allowing services to be created, managed, and orchestrated into composite applications and business or workflow processes. In addition to modeling automated or application-controlled business workflows, products such Oracle SOA Suite can also be used to model human workflows, i.e. those tasks or actions which must be performed by human users within an organization, such as reviewing a particular set of data, or approving a particular set of purchase orders or invoices. Generally, speaking such products include a graphical user interface or similar interface, that allows a process designer to modify the human workflow, to suit the needs of the organization.

While many business processes or workflow processes use human tasks for approval, some of these human tasks are complex and task routing needs to be specific based on repeating data in the task payload. For example, routing could be specific specifically for each of the lines in a purchase order. Flow languages like BPEL create a forEach branch for each of the repeating payload data. In each of the branch a separate human workflow task is created for the data in the branch. The problem with this approach is that there is no collaboration possible between these independent tasks. A uniform audit is also no possible of the human workflow task. This is the general area that embodiments of the invention are intended to address.

### SUMMARY

Described herein is a system and method for workflow task routing based on cardinality of task data, or the structure of elements in a business object associated with a task. In accordance with an embodiment, a system such as a human workflow system, that allows for the definition of human workflow tasks, can include a forEach construct within a human task routing definition and a payload. In scenarios that require a plurality of task of similar type be undertaken, such as a purchase order approval involving a plurality of items and potentially different approvers, the system allows for modeling a separate routing for each of those task items (e.g. the lines in the purchase order). In each of the branches of the forEach construct, complex routing patterns, such as parallel routing, can be used. The forEach construct allows creating of looping constructs at any level deep.

### BRIEF DESCRIPTION OF THE FIGURES

FIG. 1 shows an illustration of a human workflow environment in accordance with an embodiment.

FIG. 2 shows an illustration of a human workflow system as it may be used by a process designer to assign tasks to users, in accordance with an embodiment.

FIG. 3 shows a screenshot of a typical process design interface, as it may be used with a human workflow system or environment, in accordance with an embodiment.

FIG. 4 shows an illustration of a human workflow system that includes a means of workflow task routing based on cardinality of task data in accordance with an embodiment.

FIG. 5 shows a screenshot of an interface for configuring workflow task routing based on cardinality of task data, in accordance with an embodiment.

FIG. 6 shows an illustration of a human workflow system that incorporates workflow task routing based on cardinality of task data, in accordance with an embodiment.

FIG. 7 shows a flowchart of a method for workflow task routing based on cardinality of task data, in accordance with an embodiment.

### DETAILED DESCRIPTION

Products such as Oracle SOA Suite provide a complete set of service infrastructure components for designing, deploying, and managing composite applications, including allowing services to be created, managed, and orchestrated into composite applications and business or workflow processes. In addition to modeling automated or application-controlled business workflows, products such Oracle SOA Suite can also be used to model human workflows, i.e. those tasks or actions which must be performed by human users within an organization, such as reviewing a particular set of data, or approving a particular set of purchase orders or invoices. Generally, speaking such products include a graphical user interface or similar interface, that allows a process designer to modify the human workflow, to suit the needs of the organization.

A problem with current techniques is that, when the human workflow includes a plurality of task or action data in the form of a list, such as a list of purchase order items, each item or line on the list may be processed in a flow language such as BPEL as a set of independent tasks or branches.

Described herein is a system and method for workflow task routing based on cardinality of task data, or the structure of elements in a business object associated with a task. In accordance with an embodiment, a system such as a human workflow system, that allows for the definition of human workflow tasks, can include a forEach construct within a human task routing definition and a payload. In scenarios that require a plurality of task of similar type be undertaken, such as a purchase order approval involving a plurality of items and potentially different approvers, the system allows for modeling a separate routing for each of those task items (e.g. the lines in the purchase order). In each of the branches of the forEach construct, complex routing patterns, such as parallel routing, can be used. The forEach construct allows creating of looping constructs at any level deep.

Advantages of this approach include that it avoids the likelihood of disjoint tasks, and also allows for collaboration between tasks, and sharing of commonly defined rules (for example, that are then applied to each of the lines associated with that task).

### Glossary of Terms

Several terms which are used throughout this application are described below. It will be evident that, in accordance with different embodiments, different technologies (such as different web service languages, etc) can be used as appropriate. Additionally, in the following description, the invention will be illustrated by way of example and not by way of limitation in the figures of the accompanying drawings. References to various embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

### Business Process, Business Workflow Process

In accordance with an embodiment, a business process or business workflow process is an automated software process, defined by a process developer, which then executes within an organization, including utilizing or drawing upon other software or other organizational resources.

### Human Workflow Process

In accordance with an embodiment, a human workflow process is an automated software process, similarly defined by a process developer, which defines those tasks or actions within an organization which must be performed by human users within the organization, such as approving a particular task, or reviewing a particular set of data.

Business Process Language (e.g. BPEL, BPMN, BPM)

In accordance with an embodiment, a language such as BPEL, BMPN, or BPM can be used for business process orchestration and execution. Using such a language, a developer can design a business process that integrates a series of discrete services into an end-to-end process flow.

### Service Component Architecture (SCA)

In accordance with an embodiment, an architecture such as SCA provides the service details and interdependencies to form composite applications, and enables a developer to represent business logic as reusable service components.

### Web Services Description Language (WSDL)

In accordance with an embodiment, a language such as WSDL provides the entry points into an SOA composite application, inasmuch as a WSDL file can provide a standard contract language for understanding the capabilities of a service.

### Service Data Object (SDO)

In accordance with an embodiment, an SDO specifies a standard data method that can modify business data regardless of how it is physically accessed. Knowledge is not required about how to access a particular back-end data source to use SDO in an SOA composite application. In accordance with an embodiment, an SDO can be structured XML, and can be passed as static XML through a task payload.

### List Builders

In accordance with an embodiment, each approval stage within a human workflow process comprises one or more list builders that determine the actual list of approvers, or uses who will be assigned tasks. Examples of the types of list builders that can be used include: Names and Expressions, which construct a list using static names, or names coming from XPath expressions; Approval Groups, which include predefined approver groups in the approver list; Job Level, which ascend a supervisory hierarchy, starting at a given approver and continuing until an approver with a sufficient job level is found; Position, which ascend a position hierarchy, starting at the requester's or at a given approver's position, and goes up a specified number of levels or to a specific position; Supervisory, which ascends the primary supervisory hierarchy, starting at the requester or at given approver, and generates a chain that has a fixed number of approvers in it; Management Chain, which are based on management relationships in the corresponding user directory; and Rule-based.

### Task

In accordance with an embodiment, a task handles approvals. A different task is created for each approval requirement based on the business served by it, for example, an “approve new expense report” task or an “approve new purchase order” task. Tasks can be associated with metadata, for example task attributes such as title, outcomes (approve, reject, etc.) priority, expiration; task parameters that may be based on simple primitive types, XML elements, or external entities such as ADF view objects. Tasks can also be associated with a task payload or other data or information. A complex approval task that may include one or more stages to identify the key milestones within an approval sequence.

### Collections

In accordance with an embodiment, a collection is defined as an entity parameter for a task, and enables access to a portion of the entity, for example as an XML fragment retrieved by an XPATH expression. Once defined, collections can be associated with stages to identify a stage as acting on a collection. Defining a collection involves defining the name of the collection and the XPath to the collection element.

### Stages

In accordance with an embodiment, a stage is a set of approvals related to a collection. The same collection can be associated with multiple approval stages. A compound approval may consist of multiple stages and then can be modeled in serial or parallel with each other. Each stage consists of list builders to determine the list of approvers. Optionally, each list builder can be associated with an approval policy, that is, a set of rules. At runtime, the appropriate set of approvals are returned based on the list builders used within the stage and on the associated policies.

### Business Rules for Approval

In accordance with an embodiment, approvers of a task can be defined either inline in a task definition, or by using business rules to specify the list builders that identify the approvers of the task. Business rules can also be used to specify approver substitution and list modifications. Typically, business rules are defined by the organization or the customer, and are a combination of conditions and actions. Optionally, priority and validity periods can also be defined for the rules. In the context of the human workflow process, rule conditions can be defined using fact types that correspond to the task, and to the task message and entity attributes (which are XML representations of SDO objects). Rule actions can consist of approver list builders and their parameters. Approver list builders can then move up a particular hierarchy and construct or modify the approver list according to the parameters defined.

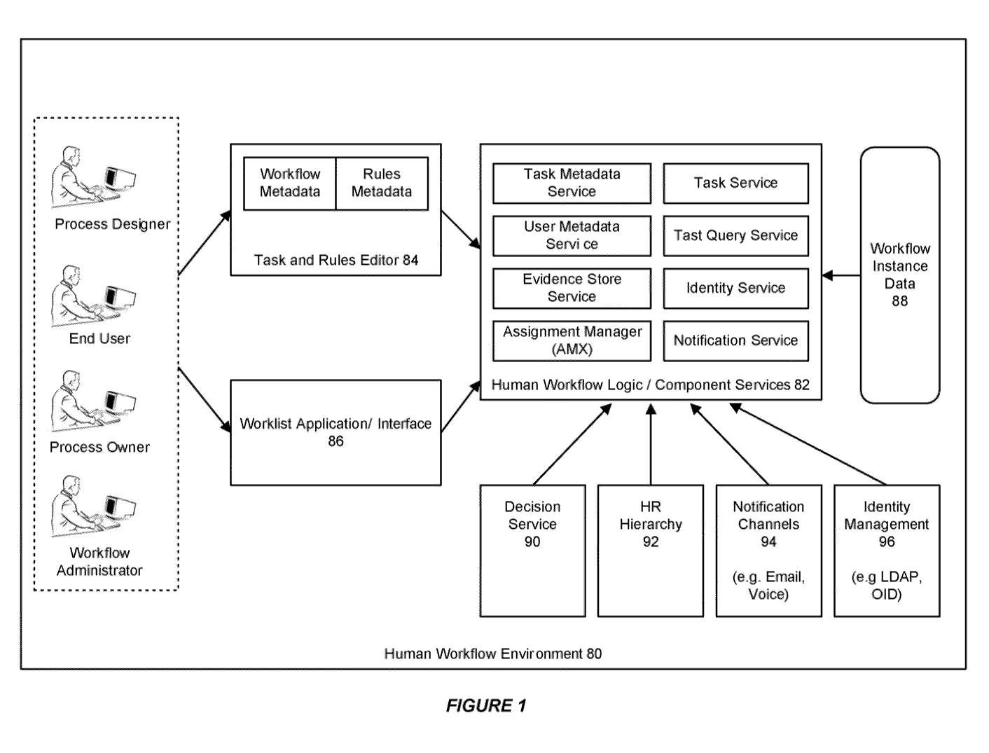

FIG. 1 shows an illustration of a human workflow environment 80 in accordance with an embodiment.

Many end-to-end business or workflow processes require human interactions with the process. For example, humans may be needed for approvals, exception management, or performing activities that are required to advance the business process. In accordance with an embodiment, the human workflow environment provides features such as: human interactions with processes, including assignment and routing of tasks to the correct users or groups; deadlines, escalations, notifications, and other features required for ensuring the timely performance of a task (human activity); presentation of tasks to end users through a variety of mechanisms, including worklist applications; organization, filtering, prioritization, and other features required for end users to productively perform their tasks; and reports, reassignments, load balancing, and other features required by supervisors and business owners to manage the performance of tasks.

As shown in FIG. 1, in accordance with an embodiment, the environment can include a human workflow logic and/or a set of component human workflow services 82, such as Approval Management extensions (AMX). The human workflow service is responsible for handling all interactions with users or groups participating in the business process, which it does by creating and tracking tasks for the appropriate users in the organization. Users typically access tasks through a variety of clients, e.g. worklist applications, email, portals, or custom applications. AMX allows a process designer to define complex task routing slips for human workflow by taking into account business documents and associated rules to determine the approval hierarchy for a work item. Additionally, AMX allows the process designer to define multi-stage approvals with associated list builders based on supervisor or position hierarchies. The approval tasks can be designed in a Human Task Editor, and then associated with a BPEL process.

The human workflow service handles requests based on task and rules metadata 84, which can be modified using a worklist application/interface 86. Core components required for approval management can include:

Human Task Editor—used to define the metadata for a human task and the routing slip. The task editor lets the process designer define such things as task parameters, outcomes, expiration and escalation, and notification settings, such as defining multi-stage approvals and associated approval list builders; or determining the approval hierarchy based on business documents (i.e. ADF objects) and business rules.

Human workflow services—which include for example a Task Service responsible for creating and managing tasks in the dehydration store; Identity Service responsible for authentication and authorization of users and groups. The service can look up various user directories for authorization and contact information for users; a Task Query Service responsible for retrieving tasks for the web-based worklist application; and a Decision Service responsible for executing business rules related to approvals.

Worklist Application—a web-based application that lets users access tasks assigned to them and perform actions based on their roles in the approval process. The worklist supports profiles such as Work assignee—an end user who is assigned a task. These users can view tasks assigned to them and perform actions, and also can define custom views and define routing rules for their tasks; Process owner—typically a business analyst responsible for managing certain types of approvals. These users can manage tasks for the processes they own, define approval groups, and change approval policies; Workflow administrator—typically a system administrator responsible for managing errored tasks, and administering and monitoring work queues. This user also may use Oracle Enterprise Manager to monitor the health of the workflow services.

Workflow instance data 88 can be stored within the system and used as part of the workflow process. The system can also retrieve information from, or provide information to, other services such as a decision service 90, HR service 92, notification channel 94, or identity management service 96. It will be evident that the above environment is an example of the type of environment in which human workflow can be used, and that in accordance with other embodiments different or additional components and services can be included.

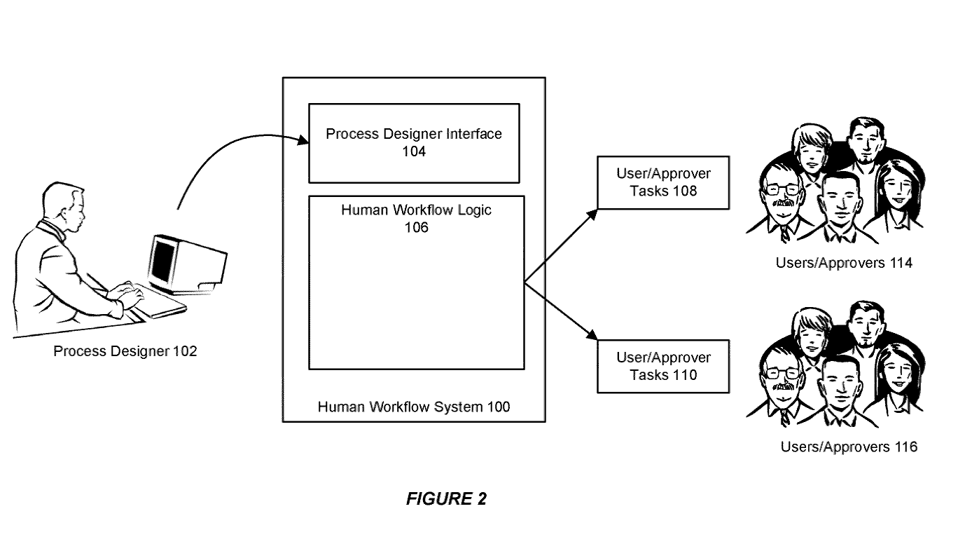

FIG. 2 shows an illustration of a human workflow system as it may be used by a process designer to assign tasks to users, in accordance with an embodiment. As shown in FIG. 2, in accordance with an embodiment, the human workflow system 100 includes a process design interface 104, such as a graphical user interface and/or a plurality of different editors and menu options. The human workflow system further includes a human workflow logic 106, such as software that executes on a processor and that executes the human workflow as designed or configured with the process design interface. A process designer or developer 102 can use the process design interface to develop and deploy human workflow processes to the system, for execution by the human workflow logic. As the workflow process executes, tasks 108, 110, such as workflow approval tasks are generated and assigned to different users/approvers 114, 116, for their involvement, such as approving a particular action, e.g. a purchase order.

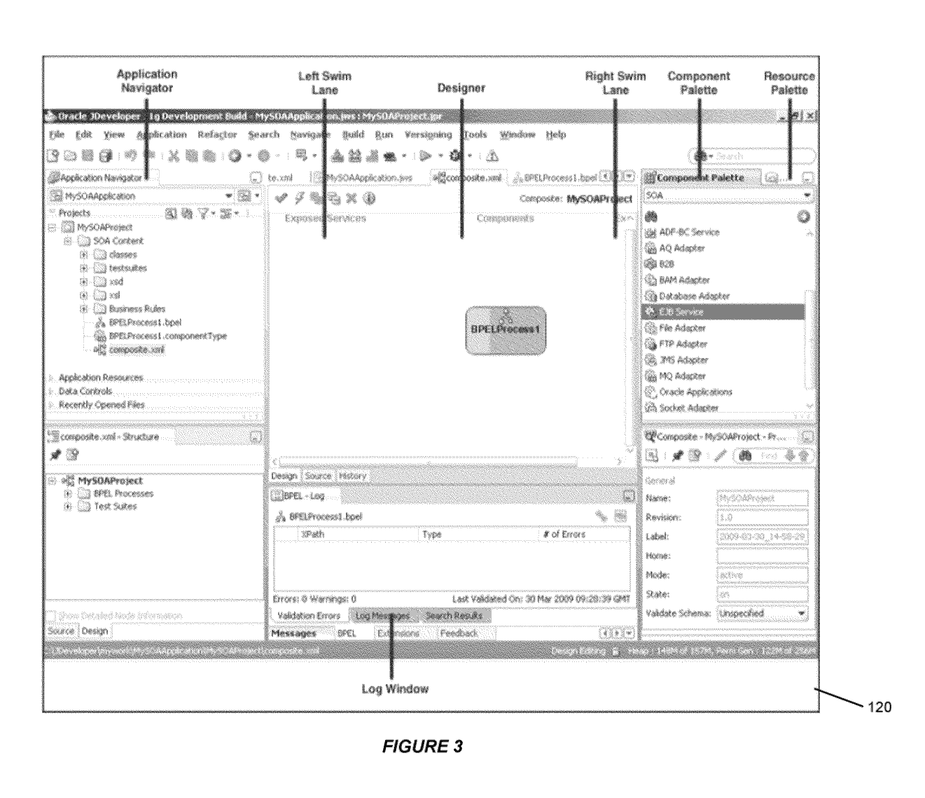

FIG. 3 shows a screenshot of a typical process design interface or editor, as it may be used with a human workflow system or environment, in accordance with an embodiment. As shown in FIG. 3, a design interface or editor 120 enables the process designer to create, edit, and deploy services, and also to assemble them in a composite application. These components are integrated together into one application and communicate with the outside world through binding components, such as web services and JCA adapters.

For example, as shown in the example of FIG. 3, a process designer can drag and drop components and service adapters from the Components Palette window to the Designer window. When they drop a service component into the Designer window, it starts a property editor for configuring that service component. For example, when they drop a Mediator component into the Designer window, this also opens the Mediator editor window that enables the designer to configure the Mediator. Service components, services, and references can be dragged into the composite in the designer, in which case a corresponding property editor is invoked for performing configuration tasks related to that service component. A left “swim lane” is provided for services providing an entry point to the SOA composite application, such as a web service or JCA adapters. A right “swim lane” is provided for references that send messages to external services in the outside world, such as web services and JCA adapters. The Component Palette contains the various resources that can be used in a SOA composite, such as service components, which displays the BPEL Process, business rule, human task, and mediator service that can be dragged and dropped into the designer; Service adapters, which displays the JCA adapter (AQ, file, FTP, Database, JMS, MQ, Oracle Applications, Oracle BAM, and EJB Service), B2B binding component, SDO binding component, and web service binding component that can be dragged into the left or right swim lanes.

It will be evident that the above process design interface or editor is an example of the type of process design interface or editor in which human workflow can be used, and that in accordance with other embodiments different or process design interfaces or editors can be included.

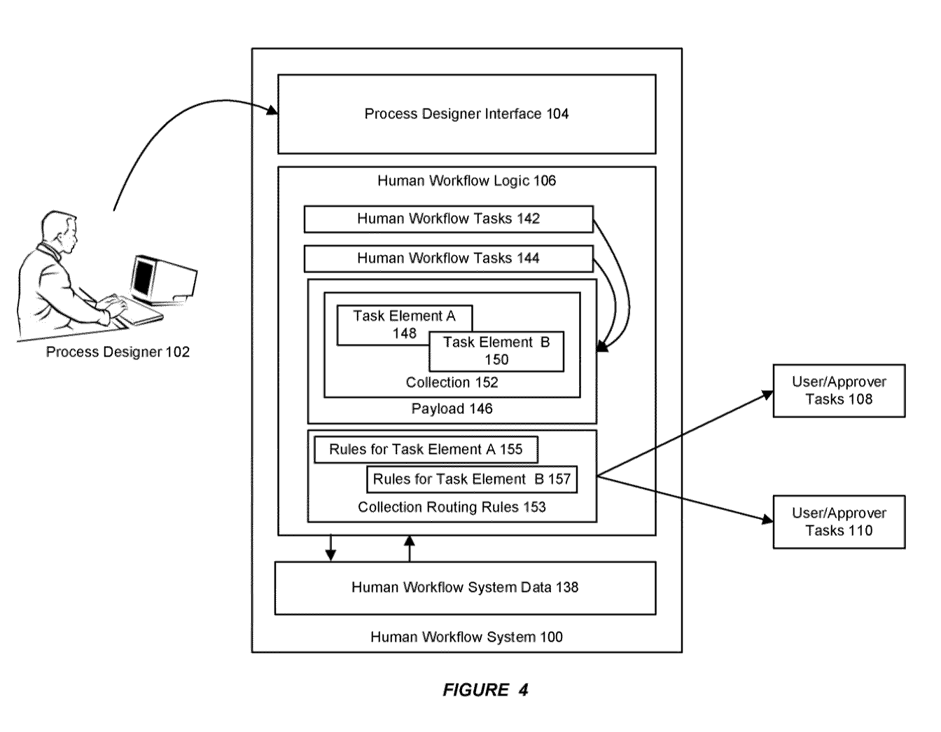

FIG. 4 shows an illustration of a human workflow system that includes a means of workflow task routing based on cardinality of task data, in accordance with an embodiment.

As shown in FIG. 4, and described above, the human workflow system 100 can include a process design interface 104 and human workflow logic 106, which allows a process designer or developer 102 to develop and deploy human workflow processes to the system, for execution by the human workflow logic. As the workflow process executes, tasks such as approval tasks 108, 110, are assigned to different users/approvers.

In accordance with an embodiment, the workflow system can include workflow system data 138, that can be associated with a plurality of workflow tasks 142, 144 managed by the system. Tasks can include a plurality of task elements 148, 150, and can be associated with a payload 146. The payload can be considered the real-time data which is necessary to complete the task, such as approval of the line items of a purchase order, or the identification of the person who must approve such a purchase order. The contents of the payload can be provided when the task is first created, and can be statically retrieved from the workflow system data, or can be modified during the workflow process. The payload as modified can then travel with the task as it is assigned to the users responsible for completing the task.

In some instances, when the human workflow includes a plurality of task or action data in the form of a list, such as a list of purchase order items, each item or line on the list may be processed in a flow language such as BPEL as a set of independent tasks or branches. However, this can introduce complexity into the workflow.

In accordance with an embodiment, tasks can include a forEach construct within a human task routing definition. In scenarios that require a plurality of task of similar type be undertaken, such as a purchase order approval involving a plurality of task elements 148, 150 and potentially different approvers, the system allows for defining a collection 152, and modeling a separate routing 153 (and/or rules 155, 157) for each of those task elements (e.g. in a purchase order implementation then for each of the lines in the purchase order). In each of the branches of the forEach construct, complex routing patterns, such as parallel or other routing, can be used. The forEach construct also allows the process designer to create looping constructs at any level deep.

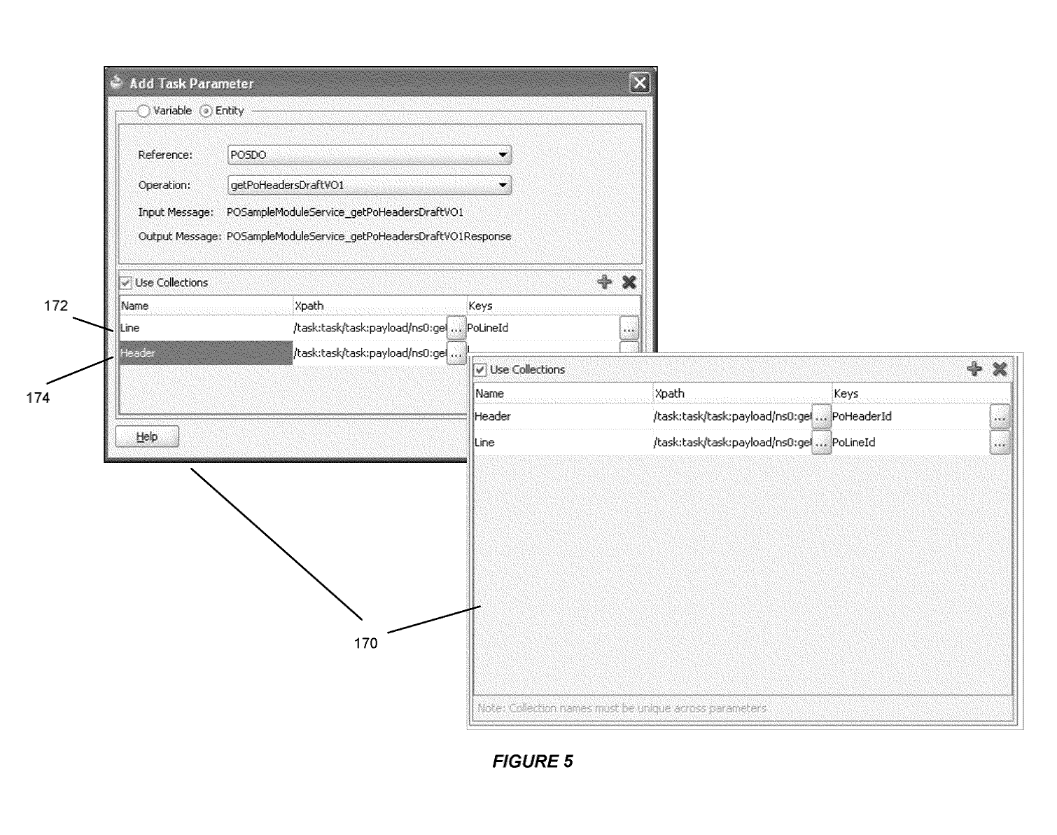

FIG. 5 shows a screenshot of an interface for configuring workflow task routing based on cardinality of task data, in accordance with an embodiment. As shown in FIG. 5, the process designer can use a graphical user interface 170 or a series of menus to define a collection. to be handled by the forEach construct. Collections are references to specific parts of a task message attribute, both static-XML based and entity attributes. Once defined, collections can then be associated with stages to identify a stage as acting on a collection. In accordance with an embodiment, defining a collection involves defining the name of the collection and the XPath to the collection element. When defining a collection, the process designer can specify whether or not the collection should be repeating; or non-repeating. A repeating collection, when associated with a stage, repeats the stage in parallel for each element in the collection at runtime. A non repeating collection specifies that there is only one stage in parallel for each element in the collection. For example, there can be multiple line items for each purchase-order header in a purchase-order scenario; if a purchase order contain 10 lines, the stage will be repeated 10 times in parallel. In the example shown in FIG. 5, PurchaseOrderHeader 174 is a non-repeating node, and PurchaseOrderLines 172 is a repeating node. In accordance with other embodiments, different interfaces, services, and/or service configuration options can be included.

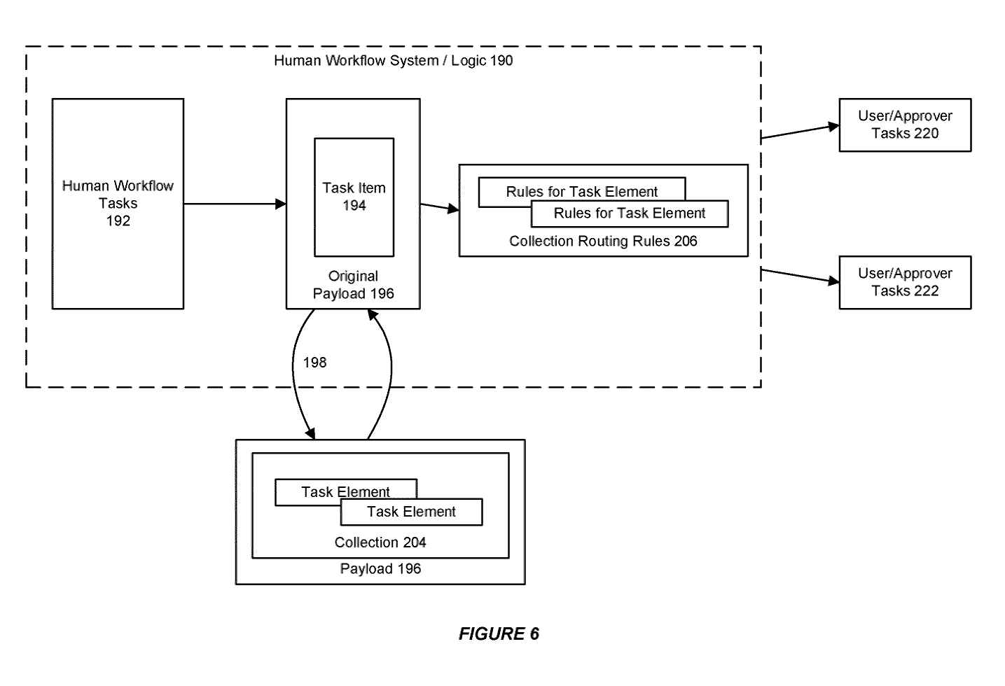

FIG. 6 shows an illustration of a human workflow system that incorporates workflow task routing based on cardinality of task data, in accordance with an embodiment. As shown in FIG. 6, during normal operation the workflow system and/or logic 190 executes a workflow process, including human workflow tasks 192. As the workflow executes, each task item 194 is associated with a payload 196. According to the process designer's configuration of collections 204 in the payload, then for each of a plurality of task elements in the collection, the system determines whether the element is a repeating, or non-repeating node, and invokes the appropriate rules 206 for those elements. Based on the outcome of these rules, the tasks and/or task elements can be assigned to the appropriate users/approvers 220, 222.

In this manner, the system avoids the likelihood of disjoint tasks, and also allows for collaboration between tasks, and sharing of commonly defined rules (for example, that are then applied to each of the lines associated with that task).

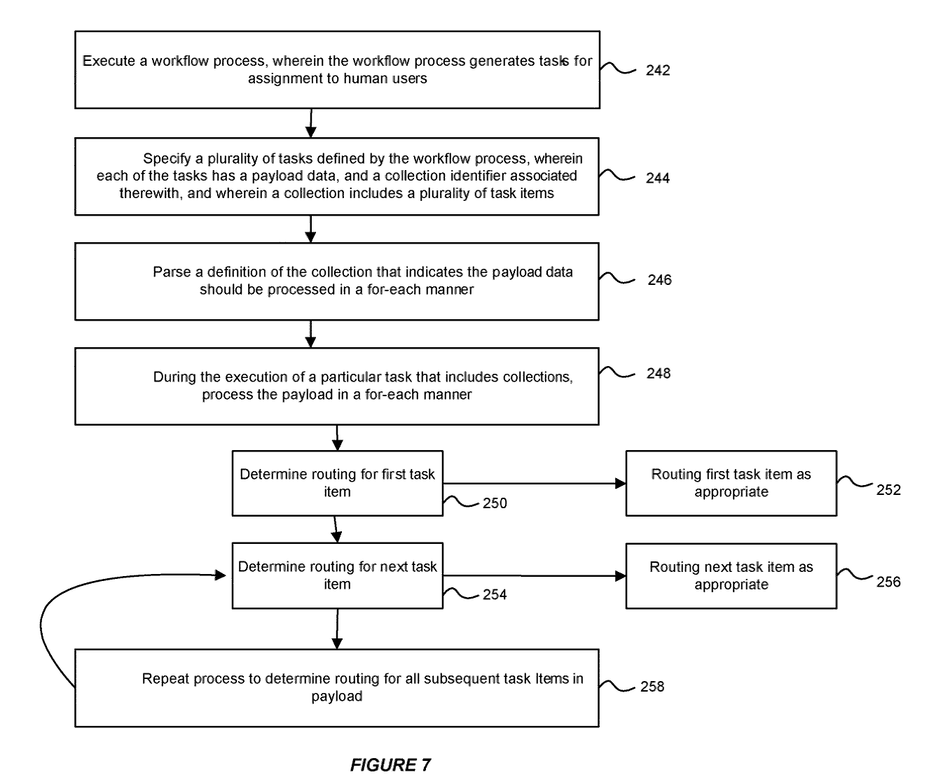

FIG. 7 shows a flowchart of a method for workflow task routing based on cardinality of task data, in accordance with an embodiment. As shown in FIG. 7, in step 242, a system such as a computer executes a workflow process, wherein the workflow process generates tasks for assignment to human users. In step 244, a process designer can specify a plurality of tasks defined by the workflow process, wherein each of the tasks has a payload data, and a collection identifier associated therewith, and wherein a collection includes a plurality of task elements. In step 246, the system parses a definition of the collection that indicates the payload data should be processed in a for-each manner. In step 248, during the execution of a particular task that includes collections, the system processes the payload in a for-each manner, including processing each of the task elements 250, 254 in the collection using its own routing rules 252, 256 respectively, and repeating these steps for each of the task elements in the payload.

The present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium or computer readable medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. In particular, although several of the embodiments described above illustrate the use of the Oracle Human Workflow system, and the use of BPEL, it will be evident that other human workflow or workflow systems, and other flow languages can be used. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A system for workflow task routing based on cardinality of task data, comprising
a computer including a workflow process executing therein, wherein the workflow process generates tasks for assignment to human users;
a plurality of tasks defined by the workflow process, wherein each of the tasks has a payload data, and a collection identifier, associated therewith, and wherein a collection includes a plurality of task elements;
a graphical user interface for use by a process designer in defining that the collection with the payload data should be processed in a for-each manner; and
wherein a the workflow process executes a particular task that includes collections, the system processes the payload in a for-each manner, including processing each of the task elements in the collection using its own routing.

2. The system of claim 1, wherein the payload can have a plurality of collections.

3. The system of claim 1, wherein the collection includes a plurality of line items.

4. The system of claim 1, wherein each task item in the collection can be processed and routed in parallel.

5. The system of claim 1, wherein collections and for-each routings can be nested.

6. A method for workflow task routing based on cardinality of task data, comprising the steps of:
executing a workflow process, wherein the workflow process generates tasks for assignment to human users;
specifying a plurality of tasks defined by the workflow process, wherein each of the tasks has a payload data, and a collection identifier, associated therewith, and wherein a collection includes a plurality of task elements;
parsing a definition of the collection that indicates the payload data should be processed in a for-each manner; and
during the execution of a particular task that includes collections, processing the payload in a for-each manner, including processing each of the task elements in the collection using its own routing.

7. The method of claim 1, wherein the payload can have a plurality of collections.

8. The method of claim 6, wherein the collection includes a plurality of line items.

9. The method of claim 6, wherein each task item in the collection can be processed and routed in parallel.

10. The method of claim 6, wherein collections and for-each routings can be nested.

11. A computer readable medium, including instructions stored thereon, which when read and executed by a computer cause the computer to perform the steps comprising:
executing a workflow process, wherein the workflow process generates tasks for assignment to human users;
specifying a plurality of tasks defined by the workflow process, wherein each of the tasks has a payload data, and a collection identifier, associated therewith, and wherein a collection includes a plurality of task elements;
parsing a definition of the collection that indicates the payload data should be processed in a for-each manner; and
during the execution of a particular task that includes collections, processing the payload in a for-each manner, including processing each of the task elements in the collection using its own routing.

12. The computer readable medium of claim 11, wherein the payload can have a plurality of collections.

13. The computer readable medium of claim 11, wherein the collection includes a plurality of line items.

14. The computer readable medium of claim 11, wherein each task item in the collection can be processed and routed in parallel.

15. The computer readable medium of claim 11, wherein collections and for-each routings can be nested.
